(19) United States
(12) Patent Application Publication
(10) Pub. No.: US 2009/0317579 A1
(43) Pub. Date: Dec. 24, 2009

(54) Arrangement for the permanent partial coverage of adhesive webs, adhesive web, and method for producing a partially adhesive web

(76) Inventors: Shaik Mohseen, Mountain Top, PA (US); Thomas M. Wilde, Malvern, PA (US); Michael Sullivan, Cape Elizabeth, ME (US); Jörg Nückel, Forchheim (DE)

Correspondence Address: COLLARD & ROE, P.C., 1077 NORTHERN BOULEVARD, ROSLYN, NY, 11576, US

(21) Appl. No.: 10/592,209

(22) PCT Filed: Mar. 9, 2005
(86) PCT No.: PCT/EP2005/051062

§ 371 Date: May 27, 2008

Related U.S. Application Data
(60) Provisional application No. 60/551,683, filed on Mar. 9, 2004.

(30) Foreign Application Priority Data
Jul. 5, 2004 (DE) 20 2004 010 576.4

(51) Int. Cl. B32B 33/00; B32B 3/24; B32B 37/00; B05D 1/36; B05D 1/00; B05D 5/00

(52) U.S. Cl. 428/41.8; 428/131; 156/60; 427/402; 427/209; 427/256

(57) ABSTRACT

Arrangement (1) for the permanent partial coverage of adhesive webs (7), particularly the coverage of self-adhesive webs (7), where a substance for covering the adhesive web is provided. The substance can take the form of a transfer substance, a covering lacquer (4), a covering film (4) or a similar material and can be provided on a substrate web (2).

The invention relates to an arrangement for the permanent partial coverage of adhesive webs, particularly the coverage of self-adhesive webs, to the web produced with the arrangement and to the process for production of the partially adhesive web.

Partial adhesive properties are desirable particularly with self-adhesive webs but also with other adhesive webs, in order to enable moisture to be transported between the web and the surface beneath it.

Various processes for the production of partially adhesive webs have been disclosed. Adhesive is applied partially in these processes.

These processes disclosed in the prior art do, however, have the disadvantage that they are difficult to handle, often have faults and cannot in addition be used at all with many adhesive webs, such as bituminous webs.

The purpose of the present invention is to propose an arrangement that enables webs which are generally adhesive over their entire surface to be covered, so that they are in the final analysis only partially adhesive. A partially adhesive web with this arrangement and a process for the production of such webs are also proposed.

In the solution to this problem proposed by the invention, a substance for covering the adhesive web is provided.

This makes it possible to cover areas of the adhesive web in a simple way, as a result of which the adhesive properties in these areas are suppressed.

It is also very advantageous in this context if the substance is provided as a transfer substance.

In another very advantageous development of the invention, the substance is provided as a covering lacquer, a covering film or a similar material.

It has proved to be very advantageous in this context if the substance, particularly the covering lacquer, the covering film or the similar material, is provided on a substrate web.

This means that the substance, particularly the covering film, the covering lacquer or the similar material, can be transferred to the adhesive web particularly easily.

It has also proved to be very advantageous in accordance with a further development of the invention if the substrate web is provided with a release finish on at least one side.

Adhesion of the adhesive web to the substrate web is avoided in this way.

It is very advantageous in this context if the release finish is provided in the form of siliconization.

Silicone has very good release properties in relation to many adhesive materials.

It is also very advantageous if the substance, particularly the covering film, the covering lacquer or the similar material, is applied to the side of the substrate web with the release finish.

It has also proved to be very advantageous if the combination of the substrate web and the substance, particularly the covering lacquer, covering film or similar material, is applied to the adhesive web, with the substance, particularly the covering lacquer, the covering film or the similar material, facing the adhesive web.

This facilitates the transfer of the substance, particularly the covering lacquer, the covering film or the similar material, to the adhesive web.

In another very advantageous further development of the invention, the substance, particularly the covering lacquer, the covering film or the similar material, is provided partially.

It is also very advantageous if the substance, particularly the covering lacquer, the covering film or the similar material, has cut-outs.

The adhesive properties of the adhesive web can be eliminated in certain areas as a result.

It has proved to be very advantageous if the cut-outs are provided in the form of holes.

This means that adhesive spots are produced on the adhesive web.

In another very advantageous further development of the invention, the substance, particularly the covering film, the covering lacquer or the similar material, is formulated to be temperature-resistant.

It is advantageous in this context if the substance, particularly the covering lacquer, the covering film or the similar material, resists temperatures of up to at least 80° C.

This makes it possible to use it for adhesive webs that are exposed to direct sunlight too.

It has also proved to be very advantageous if in accordance with the invention the substance, particularly the covering lacquer, is applied in a printing process.

In this context it is very advantageous if the substance, particularly the covering lacquer, is applied by the flexographic printing process.

It has also proved to be very advantageous if the substance, particularly the covering lacquer, is applied by the screen printing process, by the gravure, offset or letterpress printing process and/or by an exposure process.

The substance, particularly the covering lacquer, can be applied to the substrate web particularly easily and accurately with a printing process.

It is very advantageous in a process in accordance with the invention if a substance, particularly a covering lacquer, a covering film or a similar material with the appropriate outlines, is applied to a substrate web.

In this context it is extremely advantageous if the substrate web is provided with a release finish on the side on which the substance, particularly the covering lacquer, the covering film or the similar material, is to be located, before the substance, particularly the covering lacquer, the covering film or the similar material, is applied.

This on the one hand enables the substance, particularly the covering lacquer, to be applied to the substrate web precisely, while on the other hand excessively strong adhesion of the substance, particularly the covering lacquer, the covering film or the similar material, is avoided.

It is also very advantageous in this context if a silicone coating is applied as the release finish.

Silicone has proved to be a good release agent with many adhesive substances.

In another very advantageous procedure, the second side of the substrate web is provided with a release finish too.

It is very advantageous in this context if a silicone coating is applied as the release finish.

An unintentional transfer of lacquer to the second side of the substrate web and unintentional adhesion of the adhesive web are prevented as a result.

It has also proved to be extremely advantageous if the second side of the substrate web is provided with the release finish before the first side.

Any possible damage to the release finish of the first side when the finish is applied to the second side is avoided as a result.

It has also proved to be very advantageous if the substrate web is applied to the self-adhesive web with the side on which the substance, particularly the covering lacquer, the covering film or the similar material, is provided.

This means that the substance, particularly the covering film, the covering lacquer or the similar material, is transferred to the adhesive web and the adhesive web is not externally adhesive in parts.

In a very advantageous further development of a partially adhesive web, the adhesive web is covered by a covering substance, particularly a covering film, a covering lacquer or a similar material, to some extent.

This gives the web predetermined partial adhesive properties in relation to other objects.

It has also proved to be very advantageous if the web is covered with a release liner.

Unintentional adhesion of the web is avoided as a result. Rolling the web up to transport or store it is made possible too.

It has proved to be very advantageous if the substrate web acts as a release liner for the substance, particularly the covering lacquer, the covering film or the similar material.

This enables the substrate web to be put to two uses, thus avoiding waste.

In another very advantageous further development of the invention, the substance, particularly the covering lacquer, the covering film or the similar material, occupies about 50% of the area of the release liner.

50% coverage of the adhesive web on the one hand leads to good adhesive properties and on the other hand guarantees good transport of moisture etc. between the web and the surface beneath it.

It is also very advantageous if the substance, particularly the covering lacquer, the covering film or the similar material, occupies about 70% of the area of the release liner.

Although the adhesive properties of the web are somewhat worse as a result of this, the moisture transport performance is improved.

It has also proved to be very advantageous if the substance, particularly the covering lacquer, the covering film or the similar material, occupies about 30% of the area of the release liner.

The main emphasis is on the adhesive properties of the web as a result, while moisture transport is still guaranteed.

In accordance with another further development of the invention, it is very advantageous if the covering substance, particularly the covering lacquer, the covering film or the similar material, is provided with a regular pattern.

It is, however, also very advantageous if the substance, particularly the covering lacquer, the covering film or the similar material, is provided with an irregular pattern.

The adhesive properties and the transport properties can be influenced by the design of the pattern.

In another very advantageous further development of the invention, the substance, particularly the covering lacquer, the covering film or the similar material, is provided with a hole pattern.

Individual adhesive spots are produced on the web as a result.

It has also proved to be very advantageous if the substance, particularly the covering lacquer, the covering film or the similar material, is applied to the release liner in a spot pattern.

Individual non-adhesive areas are produced as a result.

In another very advantageous further development of the invention, the release liner is provided with release properties in relation not only to the covering substance, particularly the covering lacquer, the covering film or the similar material, but also to the adhesive web.

It is extremely advantageous in this context if the substance, particularly the covering lacquer, the covering film or the similar material, remains on the adhesive web when the release liner is pulled off the adhesive web.

This makes sure that the covering substance, particularly the covering lacquer, the covering film or the similar material, provided first of all on the release liner remains on the adhesive web and that the release liner can be pulled off the adhesive web easily as well.

One embodiment of the invention is illustrated in the drawings:

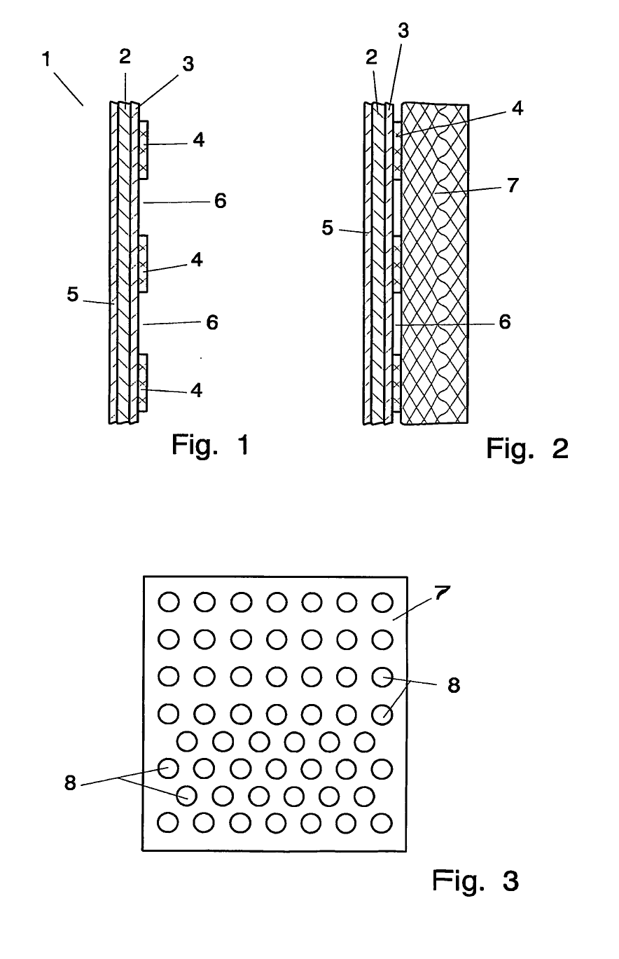

FIG. 1 shows an arrangement in accordance with the invention, with a substrate web and a covering lacquer,

FIG. 2 shows the same arrangement after it has been applied to a self-adhesive web and

FIG. 3 shows the partially adhesive web created by the arrangement.

1 in FIG. 1 is an arrangement consisting of a substrate web 2, a release finish 3 on one side of the substrate web 2 and a covering lacquer 4 applied to the release finish 3.

The covering lacquer 4 is applied partially in this context.

A further release finish 5 can be provided on the second side of the substrate web 2 facing away from the covering lacquer 4.

In the production process, the substrate web 2 is first of all provided with the second release finish 5, which can take the form of coating with a silicone or similar material. It is, however, also conceivable for the release finish 5 to be produced by incorporating a release agent such as a silicone block copolymer.

Then the first side is provided with the release finish 3, as a result of which unintentional damage to the release finish 3 in a further production operation is avoided. Like the release finish 5 on the other side, the release finish 3 can also consist of applied silicone or an incorporated release agent.

A covering lacquer 4 is applied partially to the release finish 3. It is, for example, conceivable that the covering lacquer 4 has holes 6 etc. at predetermined intervals.

The arrangement 1 is subsequently applied to an adhesive web 7. The covering lacquer 4 bonds firmly to the web 7, so that the web 7 is only adhesive externally in the areas 8 that are not covered by the covering lacquer 4. This means that the areas 8 of the web 7 that are externally adhesive correspond to the negative pattern of the covering lacquer 4. If the covering lacquer 4 has holes 6, the adhesive areas 8 take the form of spots.

After it has been combined with the web 7, the substrate web 2 acts as a release liner and thus protects the web 7 against unintentional adhesion to objects but also against unintentional adhesion to itself.

The web 7 can take the form of an adhesive or self-adhesive web, particularly a web that is self-adhesive when cold.

If the web 7 is used to seal objects of any kind, moisture etc. can be transported between a surface that is not illustrated and the web 7 in the area of the sections of the web 7 that do not have an adhesive finish. Sweating underneath the web 7 is prevented as a result.

The web 7 is exposed to direct sunlight particularly often when it is used outdoors, in warm surroundings etc., in view of which the covering lacquer 4 can be formulated to be heat-resistant. Tests have shown that temperatures of between 60 and 100° C. can be reached in this context. The covering lacquer 4 can therefore be formulated to resist temperatures of up to about at least 80° C. or higher. It is also conceivable in this context that the covering lacquer is formulated to resist temperatures of up to at least 120° C.

It is also conceivable that a covering film with appropriate outlines is applied to the release coating instead of the covering lacquer 4.

The second release finish 5 makes sure that the covering lacquer 4 is not transferred to the back of the substrate web 2 when the arrangement 1 is rolled up and stored. The second release finish 5 also avoids unintentional adhesion of the substrate web 2 to the web 7, when the web 7 is wound up together with the arrangement 1, for example to store or transport it.

1. Arrangement (1) for the permanent partial coverage of adhesive webs (7), particularly the coverage of self-adhesive webs (7), wherein a substance for covering the adhesive web is provided.

2. Arrangement according to claim 1, wherein the substance is provided as a transfer substance.

3. Arrangement according to claim 1, wherein the substance is provided as a covering lacquer (4), a covering film (4) or a similar material.

4. Arrangement according to claim 1, wherein the substance, particularly the covering lacquer (4), the covering film (4) or the similar material, is provided on a substrate web (2).

5. Arrangement according to claim 4, wherein the substrate web (2) is provided with a release finish (3) on at least one side.

6. Arrangement according to claim 3, wherein the release finish (3) is provided in the form of siliconization.

7. Arrangement according to claim 1, wherein the substance, particularly the covering film (4) or the covering lacquer (4), is applied to the side of the substrate web (2) with the release finish.

8. Arrangement according to claim 1, wherein the combination of the substrate web (2) and the substance, particularly the coveting lacquer (4) or covering film (4), is applied to the adhesive web (7), with the covering lacquer (4) or the covering film (4) facing the adhesive web (7).

9. Arrangement according to claim 1, wherein the substance, particularly the covering lacquer (4), the covering film (4) or the similar material, is provided partially.

10. Arrangement according to claim 1, wherein the substance, particularly the covering lacquer (4), the covering film (4) or the similar material, has cut-outs (6).

11. Arrangement according to claim 10, wherein the cut-outs (6) are provided in the form of holes.

12. Arrangement according to claim 1, wherein the substance, particularly the covering film (4), the covering lacquer (4) or the similar material, is formulated to be temperature-resistant.

13. Arrangement according to claim 12, wherein the substance, particularly the covering lacquer (4), the covering film (4) or the similar material, resists temperatures of up to at least 80° C.

14. Arrangement according to claim 1, wherein the substance, particularly the covering lacquer (4), is applied in a printing process.

15. Arrangement according to claim 14, wherein the substance, particularly the covering lacquer (4), is applied by the flexographic printing process.

16. Arrangement according to claim 14, wherein the substance, particularly the covering lacquer (4), is applied by the screen printing process.

17. Arrangement according to claim 14, wherein the substance, particularly the covering lacquer (4), is applied by the gravure printing process.

18. Arrangement according to claim 14, wherein the substance, particularly the covering lacquer (4), is applied by the offset or letterpress printing process.

19. Arrangement according to claim 14, wherein the substance, particularly the covering lacquer (4), is applied by an exposure process.

20. Process for the production of an arrangement according to claim 1 and for the production of a partially adhesive web, wherein a substance, particularly a covering lacquer, a covering film or a similar material with the appropriate outlines, is applied to a substrate web.

21. Process according to claim 20, wherein the substrate web (2) is provided with a release finish (3) on the side on which the substance, particularly the covering lacquer (4) or the covering film (4), is to be located, before the covering substance, particularly the covering lacquer (4) or the covering film (4), is applied.

22. Process according to claim 21, wherein a silicone coating is applied as the release finish (3).

23. Process according to claim 21, wherein the second side of the substrate web (2) is provided with a release finish (5) too.

24. Process according to claim 23, wherein a silicone coating is applied as the release finish (5).

25. Process according to claim 23, wherein the second side of the substrate web (2) is provided with the release finish (5) before the first side.

26. Process according to claim 20, wherein the substrate web (2) is applied to the adhesive web (7) with the side on which the substance, particularly the covering lacquer (4), the covering film (4) or the similar material, is provided.

27. Process according to claim 1, wherein the adhesive web (7) is covered by a substance, particularly a covering film (4), a covering lacquer (4) or a similar material, to some extent.

28. Process according to claim 27, wherein the web (7) is covered with a release liner.

29. Process according to claim 28, wherein the substrate web (2) acts as a release liner for the substance, particularly the covering lacquer (4), the covering film (4) or the similar material.

30. Process according to claim 1, wherein the substance, particularly the covering lacquer or the covering film, occupies about 50% of the area of the release liner.

31. Process according to claim 1, wherein the substance, particularly the covering lacquer or the covering film, occupies about 70% of the area of the release liner.

32. Process according to claim 1, wherein the substance, particularly the covering lacquer or the covering film, occupies about 30% of the area of the release liner.

33. Process according to claim 1, wherein the substance, particularly the covering lacquer, the covering film or the similar material, is provided with a regular pattern.

34. Process according to claim 1, wherein the substance, particularly the covering lacquer, the covering film or the similar material, is provided with an irregular pattern.

35. Process according to claim 1, wherein the substance, particularly the covering lacquer, the covering film or the similar material, is provided with a hole pattern.

36. Process according to claim 1, wherein the substance, particularly the covering lacquer, the covering film or the similar material, is applied to the release liner in a spot pattern.

37. Process according to claim 1, wherein the release liner is provided with release properties in relation not only to the substance, particularly the covering lacquer, the covering film or the similar material, but also to the adhesive web.

38. Process according to claim 1, wherein the substance, particularly the covering lacquer, the covering film or the similar material, remains on the adhesive web when the release liner is pulled off the adhesive web.
